(19) United States
(12) Patent Application Publication
(10) Pub. No.: US 2025/0259076 A1
(43) Pub. Date: Aug. 14, 2025

(54) SYSTEMS AND METHODS FOR EXECUTING VERTICAL FEDERATED LEARNING

(71) Applicant: HUAWEI TECHNOLOGIES CO., LTD., Shenzhen (CN)

(72) Inventors: Weisen SHI, Kanata (CA); Xu LI, Kanata (CA); Chenchen YANG, Kanata (CA); Bidi YING, Kanata (CA)

(21) Appl. No.: 19/191,271

(22) Filed: Apr. 28, 2025

Related U.S. Application Data
(63) Continuation of application No. PCT/CN2022/128161, filed on Oct. 28, 2022.

(51) Int. Cl. G06N 3/098

(52) U.S. Cl. CPC G06N 3/098

(57) ABSTRACT

Methods and servers for executing Vertical Federating Learning (VFL) over a communication network are disclosed. Some methods include encoder and data selection, encoder customization, and VFL configuration. Encoder and data selection includes receiving a VFL request and analyzing it to determine data requirements and encoder requirements, selecting, based on the encoder requirements, a first encoder and a second encoder, and selecting, based on the data requirements, data sources for the first encoder and for the second encoder. Encoder customization includes selecting a first encoder and a second encoder, and customizing the first encoder by muting a portion of the first encoder. The VFL configuration includes receiving labelled data information and an indication of a loss function, configuring an evaluator using the labelled data information and the indication of the loss function, configuring encoder outputs to the joint classifier, and configuring a privacy router.

### CROSS-REFERENCE TO RELATED APPLICATION

This application is a continuation of International Application No. PCT/CN2022/128161, filed on Oct. 28, 2022, the disclosure of which is hereby incorporated by reference in its entirety.

### TECHNICAL FIELD

The present disclosure relates to the field of federated learning and in particular to systems and methods for executing vertical federated learning.

### BACKGROUND

In telecommunications, “6G” is the sixth-generation standard currently under development. The 6G standard is for wireless communications technologies supporting cellular data networks. 6G networks exhibit more heterogeneity than their predecessors such as 5G networks, for example, and support applications beyond current mobile use scenarios, such as virtual and augmented reality, ubiquitous instant communications, pervasive intelligence, and the Internet of Things (IoT). Mobile network operators can adopt flexible decentralized business models for 6G networks, with local spectrum licensing, spectrum sharing, infrastructure sharing, and intelligent automated management underpinned by mobile edge computing, artificial intelligence (AI), short-packet communication and blockchain technologies.

Federated learning (FL) is one of a variety of machine learning (ML) techniques that can be leveraged for enabling 6G network capabilities. Broadly speaking, FL is an ML technique that trains one or more AI models across multiple decentralized participants (e.g., edge devices or servers) with their local datasets, without raw data exchanging between them. This approach stands in contrast to traditional “centralized” ML techniques where all the local datasets are uploaded to one executer, or which assume the sharing of raw local data samples among decentralized participants.

In other words, FL enables multiple participants to build a joint AI model without sharing data, thus allowing to address critical issues such as data privacy, data security, data access rights and access to heterogeneous data. There are two main approaches for performing FL—that is, horizontal federated learning (HFL), and the vertical federated learning (VFL).

Broadly speaking, HFL is employed on datasets of multiple participants that share the same feature space but different ID spaces. On the one hand, the feature space refers to a set of attributes/dimensions of each data entity/sample in one dataset. On the other hand, the ID space refers to the identity of each respective data entity. For example, in a bank dataset, the feature space may be (account balance, mortgage amount, credit score, etc.), while the ID space is the user list of all accounts.

In contrast to HFL, VFL is employed on datasets of multiple participants sharing the same ID space but different feature spaces. For example, Bell™ and Amazon™ have a large number of overlapping entities in the ID space (e.g., same users in real world), but different data features (e.g., mobile usage features hosted by Bell™, online shopping features hosted by Amazon™). If one, or both of these participants, want to train a joint ML model to evaluate a given user's credit score by considering the effects of both mobile usage features and online shopping features, VFL can be used to train a joint ML model without any raw data and local model information leakage between the two participants.

Since the participants of VFL may not belong to the same business or application categories, their local ML models are usually different in terms of structure and hyper-parameters. There is therefore a need for better VFL architectures that can be deployed for and used by a large variety of participants.

### SUMMARY

It is an object of the present technology to ameliorate at least some of the inconveniences present in conventional VFL architectures.

### Typical VFL Architecture

With reference to FIG. 1, there is depicted a typical VFL architecture 100 with a first participant having a first ML model 102 and a second participant having a second ML model 104. Together, this first ML model 102 and the second ML model 104 form a joint model 110.

As opposed to an HFL, two specific functionalities may be required for training and using the VFL architecture 100, namely an intermediate result exchange 106 between ML models and a collaborator 108.

According to the VFL paradigm, in each training step and each in-use step of the joint model 110, the intermediate output or computing result of first local ML model 102 and of the second local ML model 104 may need to be encrypted by homomorphic encryption first, and then, may be transmitted to the other one amongst the first local ML model 102 and the second local ML model 104 for them to perform their local computing. Each of the first local ML model 102 and the second local ML model 104 joined in the intermediate result exchange process 106 do not decrypt the intermediate results from the other one of the first local ML model 102 and the second local ML model 104—that is, they perform local computing of the homomorphic-encrypted data.

In order to ensure the confidentiality of the data during the training process, the collaborator 108 is required for performing VFL. For example, the collaborator 108 may be a third-party entity trusted by the first participant and the second participant. The collaborator 108 may be embodied as a secure computing node, as a non-limiting example. The collaborator 108 creates encryption pairs and sends the public key to the first participant and to the second participant to enable the encrypted intermediate result exchange process 106. Once the intermediate result exchange process 106 is completed for each training and in-use step of the joint model 110, the first participant and the second participant send their encrypted outputs and locally generated masks to the collaborator 108. The collaborator 208 decrypts their masked outputs by the private key, calculates the decrypted gradients and loss, and sends this information back to the respective participants. Each participant unmasks the gradient and loss from the collaborator 208 and updates its respective local ML model parameters accordingly.

Developers have realized that VFL may need to be supported by the NET4AI architecture for providing native support to the training and in-use phases of AI-based computing services. Broadly, NET4AI is a service-oriented architecture for 6G wireless systems which provides E2E support to AI applications, from deployment phase to operation phase. The NET4AI architecture is generally described in an article entitled “Nine Challenges in Artificial Intelligence and Wireless Communications for 6G”, authored by Wen Tong and Geoffry Ye Li, published in 2021, DOI 10.1109/MWC.006.2100543, the contents of which is incorporated herein by reference in its entirety. Supporting VFL in the NET4AI architecture is a challenging task.

Developers have realized that in existing VFL paradigms, the VFL customer has access to information indicative of a number of other VFL participants, data features of other VFL participants, datasets of other VFL participants, labelled data location/ownership, as well as encoder structures of other VFL participants. However, when implementing an automated VFL system, the VFL customer may not have access to information about other VFL participants. As such, developers of the present technology have realized that there is a need for systems and methods which allow the NET4AI architecture to select datasets and encoders with necessary features for the VFL customer.

Developers have also realized that in existing VFL paradigms, labelled data is provided by one single VFL participant, and the loss function can be split without violating homomorphic encryption. As a result, privacy preserving intermediate result exchange processes can be executed for computing the joint loss. However, in some cases, labelled data may be owned at least partially by multiple participants. Also, some loss functions can differ from linear polynomial functions that ensure homomorphic encryption after computation. As such, developers have realized that there may be a need to configure a joint classifier and an evaluator for different encoders. This may simplify interactions between local classifiers of different VFL participants, and/or may support loss functions that violate homomorphic encryption, and/or may allow labeled data to be provided by multiple data sources.

Developers have also realized that in existing VFL paradigms, the encoder structure maintained by a corresponding AI enabler remains the same. In these solutions, there is a lack of procedures for customizing encoder structure for specific cases such as, for example, cooperatively training and using multiple encoders to form a joint model. However, when applying VFL in NET4AI architecture, or other architectures, the training data of selected participants may have overlapped data features.

For example, in a VFL model with a “bank” participant and a “mobile operator” participant, the data of both participants may have a common feature named “mobile bill payment record”. In this example, if the VFL joint model is formed by the original encoders of the two participants, the weight of feature “mobile bill payment record” in the joint output can be significantly increased due to duplication in both model inputs. In the same example, weights of other features may be reduced in the joint output without being duplicated.

Developers have realized that although it is possible to alleviate the problem of relatively increased weight of an overlapped feature by setting a strict convergence requirement, the overall training cost may increase significantly. Therefore, developers have realized that customization of encoder structures may be desirable for reducing drawbacks such as, for example, relatively increased weights and slow convergence speed caused by overlapped data features.

### Typical Encoder-Classifier Model

With reference to FIG. 2, there is depicted a simplified representation of a typical local ML model 200. For example, the local ML model 200 may be a Deep Neural Network (DNN) executed by a respective computing service (e.g., a participant).

The local ML model 200 comprises an encoder 202 and a classifier 204, each including a number of layers. As seen in FIG. 2, layers two to four are sometimes referred to as “hidden” layers. The encoder 202 includes an input layer 206 and a number of hidden layers, while the classifier 204 includes the remaining hidden layers and the output layer.

The encoder 202 captures low-order features of the local ML model 200 and which can be shared with other local ML models that are implemented in a similar manner to the local ML model 200 (e.g., local ML models with a goal of solving a similar problem). The classifier 204 captures high-order features of the local ML model 200 and which are usually goal-specific. For the input layer 206 of the encoder 202, each neuron corresponds to one feature of input data. The dimension of the input layer 206, i.e., number of neurons of the input layer 206, equals to the number of features associated with the input data of the local ML model 200.

Developers of the present technology have realized that, when executing automated VFL, an encoder can be a network-supplied encoder, i.e. provided by the network and implemented by a network entity, referred to as an “AI enabler”. It is contemplated that during automated VFL execution, the classifier may be at least one of (i) a customer-supplied classifier, i.e. local classifier provided by the participant of corresponding ML enabler, and (ii) a network-supplied classifier, i.e., joint classifier provided by the orchestrator in NET4AI architecture, or other architectures. It is contemplated that both the customer-supplied classifiers and network-supplied classifiers can be implemented via a service function of the computing service, without departing from the scope of the present technology.

Developers of the present technology have realized that Neural Network (NN) pruning techniques can be employed for reducing the size of the NN by “muting” specific neurons or links of the NN, while keeping the same or similar performance as the corresponding full-size NN. Muting of a neuron can be implemented by forcing its outputs to be equal to zero for any input. Muting a link can be implemented by setting the weight value of the link to zero.

Typically, during NN pruning, the neurons of a given input layer are not muted. However, in some embodiments of the present technology, at least some neurons of at least some input layers of encoders of respective VFL participants may be muted to reduce the detrimental effects caused by overlapped data features. The process of changing the structure of the encoder by muting specific neurons or links of a given layer (potentially input layer) can be referred to as encoder customization procedure, or encoder pruning.

In some embodiments of the present technology, a VFL participant includes an encoder, a local classifier (if available), and the corresponding data source. The data source of a VFL participant may comprise multiple datasets implemented at different network locations. All data entities provided by the data source of a VFL participant may have a same format and same features. Since each encoder is associated with an application category, the data source of the VFL participant may be associated with the same application category as that of the encoder of the VFL participant.

### PRESENT TECHNOLOGY

In a first broad aspect of the present technology, there is provided a method comprising: receiving, by an encoder selector, a Vertical Federated Learning (VFL) request from a VFL customer; determining, by the encoder selector, data requirements and encoder requirements for solving a VFL task according to the VFL request, the VFL task being splittable into a plurality of sub-tasks, the plurality of sub-tasks at least including a first sub-task and a second sub-task; selecting, by the encoder selector based on the encoder requirements, a first encoder and a second encoder being from a pool of encoders in the communication network, the first encoder configured to process a first set of features for solving the first sub-task, the second encoder configured to process a second set of features for solving the second sub-task; selecting, by the encoder selector based on the data requirements, a first data source for the first encoder and a second for the second encoder, the selected data sources being from a pool of data sources, the first data source comprising the first set of features, and the second data source comprising the second set of features.

In some embodiments of the method, the data requirements are indicative of requirements for selecting the first data source for solving the first sub-task, and the second data source for solving the second sub-task.

In some embodiments of the method, the encoder requirements are indicative of a first encoder structure to be used for solving the first sub-task and a second encoder structure to be used for solving the second sub-task.

In some embodiments of the method, the method further comprises splitting, by the encoder selector, the VFL task into the plurality of sub-tasks.

In some embodiments of the method, the selecting the first encoder comprises: determining, by the encoder selector, an application category of the first sub-task based on the encoder requirements, the application category being stored in a memory in association with the first encoder.

In some embodiments of the method, the selecting the first encoder comprises: identifying, by the encoder selector, the pool of encoders that has the first encoder structure; and selecting, by the encoder selector, the first encoder from the pool of encoders that has the first encoder structure.

In some embodiments of the method, the selecting the first data source and the second data source comprises: sending, by the encoder selector to a data source manager, a request for data source information, the request including the data requirements; receiving, by the encoder selector from the data source manager, the data source information indicative of quality of and features of data included in respective ones from the pool of data sources; selecting, by the encoder selector using the data source information, the first data source for the first encoder and the second data source for the second encoder.

In some embodiments of the method, the first data source and the second data source are associated with respective IDs, the method further comprising: sending, by the encoder selector to the data source manager, the respective IDs of the first data source and the second data source; and receiving, by the encoder selector from the data source manager, network locations of the first data source and the second data source.

In a second broad aspect of the present technology, there is provided a method comprising: customizing, by the encoder customizer, a first encoder by muting a portion of the first encoder, thereby generating a customized first encoder. The first encoder and a second encoder have been selected based on encoder requirements from a pool of encoders in a communication network, the encoder requirements having been determined for solving a Vertical Federated Learning (VFL) task according to a VFL request. The VFL task is splittable into a plurality of sub-tasks, the plurality of sub-tasks including at least a first sub-task and a second sub-task. The first encoder is configured to process a first set of features for solving the first sub-task, the second encoder configured to process a second set of features for solving the second sub-task.

In some embodiments of the method, the customizing includes: determining overlapping features between the first set of features and the second set of features; and muting the portion of the first encoder that processes the overlapping features.

In some embodiments of the method, the customizing includes determining, by the encoder customizer, that the first encoder is to be customized.

In some embodiments of the method, the determining, by the encoder customizer, that the first encoder is to be customized includes determining, by the encoder customizer based on a data feature weights, that the first encoder is to be customized, the data feature weights having been received from a referred AI enabler.

In some embodiments of the method, the customizing the first encoder comprises muting, by the encoder customizer, the portion of the first encoder that processes the overlapping features. The muting includes muting at least one of a neuron of the first encoder and a link of the first encoder.

In a third broad aspect of the present technology, there is provided a method comprising configuring, by a Vertical Federated Learning (VFL) configurator, at least one of an evaluator and a joint classifier; and configuring, by the VFL configurator, a privacy router to determine at least one of: data exchange routes between the joint classifier and the evaluator, labelled data merging routes between the evaluator and one or more data sources, and backpropagation routes between the joint classifier and a customized first encoder and a second encoder for back-propagating gradient values, wherein the joint classifier, the evaluator and the privacy router configured for performing VFL.

In some embodiments of the method, the configuring the evaluator comprises: receiving, by the VFL configurator, labelled data information from an encoder selector; determining, by the VFL configurator, a loss function to be used for performing VFL; and configuring, by the VFL configurator, the evaluator using the labelled data information and the loss function.

In some embodiments of the method, the configuring the evaluator comprises configuring, by the VFL configurator, a combination rule for labelled data originating from data sources selected for a first encoder and a second encoder, and the loss function.

In some embodiments of the method, the configuring the joint classifier comprises: receiving, by the VFL configurator, information indicative of an output layer structure of the first encoder and of the second encoder from an encoder customizer; configuring, by the VFL configurator, encoder outputs to the joint classifier based on the output layer structure of the first encoder and of the second encoder.

In some embodiments of the method, the second encoder is a customized second encoder.

In a fourth broad aspect of the present technology, there is provided an encoder selector configured to: receive a Vertical Federated Learning (VFL) request from a VFL customer; determine data requirements and encoder requirements for solving a VFL task according to the VFL request, the VFL task being splittable into a plurality of sub-tasks, the plurality of sub-tasks at least including a first sub-task and a second sub-task; select based on the encoder requirements, a first encoder and a second encoder being from a pool of encoders in the communication network, the first encoder configured to process a first set of features for solving the first sub-task, the second encoder configured to process a second set of features for solving the second sub-task; select based on the data requirements, a first data source for the first encoder and a second for the second encoder, the selected data sources being from a pool of data sources, the first data source comprising the first set of features, and the second data source comprising the second set of features.

In some embodiments of the encoder selector, the data requirements are indicative of requirements for selecting the first data source for solving the first sub-task, and the second data source for solving the second sub-task.

In some embodiments of the encoder selector, the encoder requirements are indicative of a first encoder structure to be used for solving the first sub-task and a second encoder structure to be used for solving the second sub-task.

In some embodiments of the encoder selector, encoder selector is further configured to split VFL task into the plurality of sub-tasks.

In some embodiments of the encoder selector, to select the first encoder comprises the encoder selector configured to determine an application category of the first sub-task based on the encoder requirements, the application category being stored in a memory in association with the first encoder.

In some embodiments of the encoder selector, to select the first encoder comprises the encoder selector configured to: identify the pool of encoders that has the first encoder structure; and select the first encoder from the pool of encoders that has the first encoder structure.

In some embodiments of the encoder selector, to select the first data source and the second data source comprises the encoder selector configured to: send, to a data source manager, a request for data source information, the request including the data requirements; receive, from the data source manager, the data source information indicative of quality of and features of data included in respective ones from the pool of data sources; select, using the data source information, the first data source for the first encoder and the second data source for the second encoder.

In some embodiments of the encoder selector, the first data source and the second data source are associated with respective IDs, the encoder selector is further configured to: send, to the data source manager, the respective IDs of the first data source and the second data source; and receive, from the data source manager, network locations of the first data source and the second data source.

In a fifth broad aspect of the present technology, there is provided an encoder customizer configured to: customize a first encoder by muting a portion of the first encoder, thereby generate a customized first encoder. The first encoder and a second encoder have been selected based on encoder requirements from a pool of encoders in a communication network, the encoder requirements having been determined for solving a Vertical Federated Learning (VFL) task according to a VFL request. The VFL task is splittable into a plurality of sub-tasks, the plurality of sub-tasks including at least a first sub-task and a second sub-task. The first encoder is configured to process a first set of features for solving the first sub-task, the second encoder configured to process a second set of features for solving the second sub-task.

In some embodiments of the encoder customizer, to customize includes the encoder customizer configured to: determine overlapping features between the first set of features and the second set of features; and mute the portion of the first encoder that processes the overlapping features.

In some embodiments of the encoder customizer, to customize includes the encoder customizer configured to determine that the first encoder is to be customized.

In some embodiments of the encoder customizer, to determine that the first encoder is to be customized includes the encoder customizer configured to: determine, based on a data feature weights, that the first encoder is to be customized, the data feature weights having been received from a referred AI enabler.

In some embodiments of the encoder customizer, to customize the first encoder comprises the encoder customizer configured to mute the portion of the first encoder that processes the overlapping features, the muting including muting at least one of a neuron of the first encoder and a link of the first encoder.

In a sixth broad aspect of the present technology, there is provided a Vertical Federated Learning (VFL) configurator configured to: configure at least one of an evaluator and a joint classifier; configure a privacy router to determine at least one of: data exchange routes between the joint classifier and the evaluator, labelled data merging routes between the evaluator and one or more data sources, and backpropagation routes between the joint classifier and a customized first encoder and a second encoder for back-propagating gradient values, wherein the joint classifier, the evaluator and the privacy router configured for performing VFL.

In some embodiments of the VFL configurator, to configure the evaluator comprises the VFL configurator configured to: receive labelled data information from an encoder selector; determine a loss function to be used for performing VFL; and configure the evaluator using the labelled data information and the loss function.

In some embodiments of the VFL configurator, to configure the evaluator comprises the VFL configurator configured to configure a combination rule for labelled data originating from data sources selected for a first encoder and a second encoder, and the loss function.

In some embodiments of the VFL configurator, to configure the joint classifier comprises the VFL configurator configured to: receive information indicative of an output layer structure of the first encoder and of the second encoder from an encoder customizer; configure encoder outputs to the joint classifier based on the output layer structure of the first encoder and of the second encoder.

In some embodiments of the VFL configurator, the second encoder is a customized second encoder.

In a seventh broad aspect of the present technology, there is provided a method comprising: receiving, by an encoder selector, a Vertical Federated Learning (VFL) request from a VFL customer; determining, by the encoder selector, data requirements and encoder requirements for solving a VFL task according to the VFL request, the VFL task being splittable into a plurality of sub-tasks, the plurality of sub-tasks at least including a first sub-task and a second sub-task; selecting, by the encoder selector based on the encoder requirements, a first encoder and a second encoder being from a pool of encoders in the communication network, the first encoder configured to process a first set of features for solving the first sub-task, the second encoder configured to process a second set of features for solving the second sub-task; selecting, by the encoder selector based on the data requirements, a first data source for the first encoder and a second for the second encoder, the selected data sources being from a pool of data sources, the first data source comprising the first set of features, and the second data source comprising the second set of features; customizing, by an encoder customizer, a first encoder by muting a portion of the first encoder, thereby generating a customized encoder; configuring, by a VFL configurator, at least one of an evaluator and a joint classifier; configuring, by the VFL configurator, a privacy router to determine at least one of: data exchange routes between the joint classifier and the evaluator, labelled data merging routes between the evaluator and one or more of the selected data sources, and backpropagation routes between the joint classifier and each one of a customized first encoder and a second encoder for back-propagating gradient values, wherein the joint classifier, the evaluator and the privacy router configured for performing VFL.

In some embodiments of the method, the data requirements are indicative of requirements for selecting the first data source for solving the first sub-task, and the second data source for solving the second sub-task.

In some embodiments of the method, the encoder requirements are indicative of a first encoder structure to be used for solving the first sub-task and a second encoder structure to be used for solving the second sub-task.

In some embodiments of the method, the method further comprises splitting, by the encoder selector, the VFL task into the plurality of sub-tasks.

In some embodiments of the method, the selecting the first encoder comprises: determining, by the encoder selector, an application category of the first sub-task based on the encoder requirements, the application category being stored in a memory in association with the first encoder.

In some embodiments of the method, the selecting the first encoder comprises: identifying, by the encoder selector, the pool of encoders that has the first encoder structure; and selecting, by the encoder selector, the first encoder from the pool of encoders that has the first encoder structure.

In some embodiments of the method, the selecting the first data source and the second data source comprises: sending, by the encoder selector to a data source manager, a request for data source information, the request including the data requirements; receiving, by the encoder selector from the data source manager, the data source information indicative of quality of and features of data included in respective ones from the pool of data sources; selecting, by the encoder selector using the data source information, the first data source for the first encoder and the second data source for the second encoder.

In some embodiments of the method, the first data source and the second data source are associated with respective IDs. The method further comprises: sending, by the encoder selector to the data source manager, the respective IDs of the first data source and the second data source; and receiving, by the encoder selector from the data source manager, network locations of the first data source and the second data source.

In some embodiments of the method, the customizing includes: determining overlapping features between the first set of features and the second set of features; and muting the portion of the first encoder that processes the overlapping features.

In some embodiments of the method, the customizing includes determining, by the encoder customizer, that the first encoder is to be customized.

In some embodiments of the method, the determining, by the encoder customizer, that the first encoder is to be customized includes determining, by the encoder customizer based on a data feature weights, that the first encoder is to be customized, the data feature weights is received from a referred AI enabler.

In some embodiments of the method, the customizing the first encoder comprises: muting, by the encoder customizer, the portion of the first encoder that processes the overlapping features, the muting including muting at least one of a neuron of the first encoder and a link of the first encoder.

In some embodiments of the method, the configuring the evaluator comprises: receiving, by the VFL configurator, labelled data information from the encoder selector; determining, by the VFL configurator, a loss function to be used for performing VFL; and configuring, by the VFL configurator, the evaluator using the labelled data information and the loss function.

In some embodiments of the method, the configuring the evaluator comprises: configuring, by the VFL configurator, a combination rule for labelled data originating from data sources selected for a first encoder and a second encoder, and the loss function.

In some embodiments of the method, the configuring the joint classifier comprises: receiving, by the VFL configurator, information indicative of an output layer structure of the first encoder and of the second encoder from an encoder customizer; configuring, by the VFL configurator, encoder outputs to the joint classifier based on the output layer structure of the first encoder and of the second encoder.

In some embodiments of the method, the second encoder is a customized second encoder.

In an eight broad aspect of the present technology, there is provided a system configured to: receive, by an encoder selector, a Vertical Federated Learning (VFL) request from a VFL customer; determine, by the encoder selector, data requirements and encoder requirements for solving a VFL task according to the VFL request, the VFL task being splittable into a plurality of sub-tasks, the plurality of sub-tasks at least including a first sub-task and a second sub-task; select, by the encoder selector based on the encoder requirements, a first encoder and a second encoder being from a pool of encoders in the communication network, the first encoder configured to process a first set of features for solving the first sub-task, the second encoder configured to process a second set of features for solving the second sub-task; select, by the encoder selector based on the data requirements, a first data source for the first encoder and a second for the second encoder, the selected data sources being from a pool of data sources, the first data source comprising the first set of features, and the second data source comprising the second set of features; customize, by an encoder customizer, a first encoder by muting a portion of the first encoder, thereby generating a customized encoder; configure, by a VFL configurator, at least one of an evaluator and a joint classifier; configure, by the VFL configurator, a privacy router to determine at least one of: data exchange routes between the joint classifier and the evaluator, labelled data merging routes between the evaluator and one or more of the selected data sources, and backpropagation routes between the joint classifier and each one of a customized first encoder and a second encoder for back-propagating gradient values, wherein the joint classifier, the evaluator and the privacy router configured for performing VFL.

In some embodiments of the system, the data requirements are indicative of requirements for selecting the first data source for solving the first sub-task, and the second data source for solving the second sub-task.

In some embodiments of the system, the encoder requirements are indicative of a first encoder structure to be used for solving the first sub-task and a second encoder structure to be used for solving the second sub-task.

In some embodiments of the system, the encoder selector is further configured to split the VFL task into the plurality of sub-tasks.

In some embodiments of the system, to select the first encoder comprises the encoder selector configured to: determine an application category of the first sub-task based on the encoder requirements, the application category being stored in a memory in association with the first encoder.

In some embodiments of the system, to select the first encoder comprises the encoder selector configured to: identify the pool of encoders that has the first encoder structure; and select the first encoder from the pool of encoders that has the first encoder structure.

In some embodiments of the system, to select the first data source and the second data source comprises the encoder selector configured to: send, to a data source manager, a request for data source information, the request including the data requirements; receive, from the data source manager, the data source information indicative of quality of and features of data included in respective ones from the pool of data sources; select, using the data source information, the first data source for the first encoder and the second data source for the second encoder.

In some embodiments of the system, the first data source and the second data source are associated with respective IDs, the encoder selector is further configured to: send, to the data source manager, the respective IDs of the first data source and the second data source; and receive, from the data source manager, network locations of the first data source and the second data source.

In some embodiments of the system, to customize comprises the encoder customizer configured to: determine overlapping features between the first set of features and the second set of features; and mute the portion of the first encoder that processes the overlapping features.

In some embodiments of the system, to customize comprises the encoder customizer configured to: acquire (i) encoder structure parameters of the first encoder and of the second encoder, (ii) location of a target AI enabler for the customized encoder, (iii) location of a referred AI enabler of a trained encoder; send, to the referred AI enabler, a request for data feature weights of the trained encoder; receive, from the referred AI enabler, the data feature weights; determine overlapping features between the first set of features of the first encoder and the second set of features of the second encoder; determine, based on the data feature weights, that the first encoder is to be customized; mute the portion of the first encoder that processes the overlapping features, to mute including muting at least one of a neuron of the first encoder and a link of the first encoder.

In some embodiments of the system, to configure the evaluator comprises the VFL configurator configured to: receive labelled data information from the encoder selector; determine a loss function to be used for performing VFL; and configure the evaluator using the labelled data information and the loss function.

In some embodiments of the system, to configure the evaluator comprises the VFL configurator configured to: configure a combination rule for labelled data originating from data sources selected for a first encoder and a second encoder, and the loss function.

In some embodiments of the system, to configure the joint classifier comprises the VFL configurator configured to: receive information indicative of an output layer structure of the first encoder and of the second encoder from an encoder customizer; configure encoder outputs to the joint classifier based on the output layer structure of the first encoder and of the second encoder.

In some embodiments of the system, the second encoder is a customized second encoder.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments of the present disclosure will be described by way of example only with reference to the accompanying drawings, in which:

FIG. 1 illustrates a schematic representation of a typical VFL architecture with two participants.

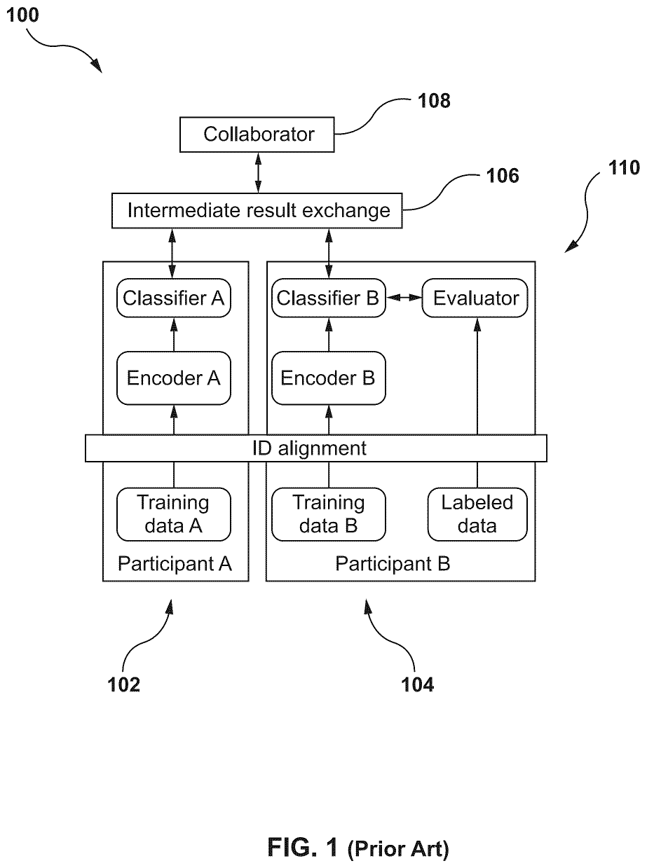

FIG. 2 illustrates a schematic representation of a typical local ML model.

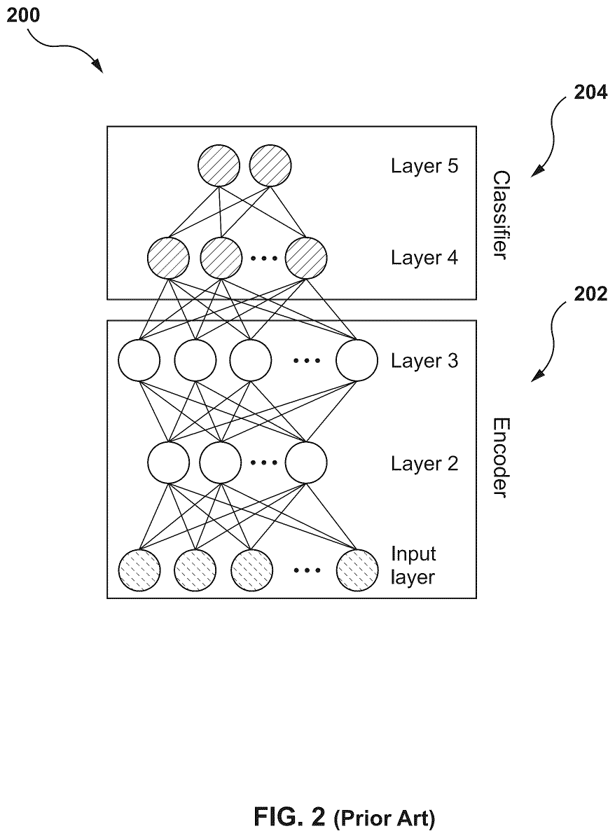

FIG. 3 illustrates a schematic representation of an automated VFL architecture as contemplated in some embodiments of the present technology.

FIG. 4 illustrates a schematic representation of a privacy rooter of the automated VFL architecture of FIG. 3.

FIG. 5 illustrates a schematic representation of an encoder and data selection procedure performed by an encoder selector of the VFL architecture of FIG. 3.

FIG. 6 illustrates a schematic representation of an encoder customization procedure performed by an encoder customizer of the VFL architecture of FIG. 3.

FIG. 7 illustrates two customization modes of the encoder customization procedure of FIG. 6.

FIG. 8 illustrates a schematic representation of a VFL configuration procedure performed by a VFL configurator of the VFL architecture of FIG. 3.

FIG. 9 illustrates three VFL frameworks including a traditional VFL, an automated VFL, and a stitched single-NN.

FIG. 10 illustrates a performance comparison between the traditional VFL and the automated VFL of FIG. 9 applied to the two test datasets.

FIG. 11 illustrates a performance comparison between the automated VFL and the stitched single-NN of FIG. 9 applied to the two test datasets.

### DETAILED DESCRIPTION

Broadly speaking, sixth generation (6G) communication systems are End-to-End (E2E) systems that support AI-based services and applications in a variety of contexts and scenarios. For example, a 6G network component can natively integrate communication, computing, and sensing capabilities for facilitating the transition from centralized intelligence in the cloud to ubiquitous intelligence on “deep” edges. This integration can be enabled by what is referred to herein as a “Network for AI” (NET4AI) architecture. The NET4AI architecture may allow provision of AI as a Service (AIaaS). However, as it will become apparent from the description herein further below, at least some aspects of the present technology may be embodied in a large variety of AIaaS architectures.

In the context of the present technology, developers have developed methods and systems for automating Vertical Federated Learning (VFL). Broadly, VFL is a Machine Learning (ML) technique that employs heterogeneous AI models and datasets belonging to different participants to train a joint model. Developers of the present technology have realized that supporting automated VFL in the NET4AI architecture, or other architectures, may be beneficial.

In accordance with some non-limiting embodiments of the present technology, there is provided an automated VFL methods and systems for customers to employ data and computing resources of other customers, even if they belong to different organizations or even industry areas. As it will be described in greater details herein further below, VFL automation may be enabled using at least some of the following functionalities: an encoder and data selection, encoder customization, and VFL configuration.

In further non-limiting embodiments of the present technology, there is provided an automated VFL solution that supports AI model customization. Broadly speaking, customization of AI models is a functionality of the automated VFL solution for improving the scalability of an AI model in heterogeneous devices and scenarios. As it will be described in greater details herein further below, AI model customization may be enabled via the encoder customization function.

### Automated VFL Architecture

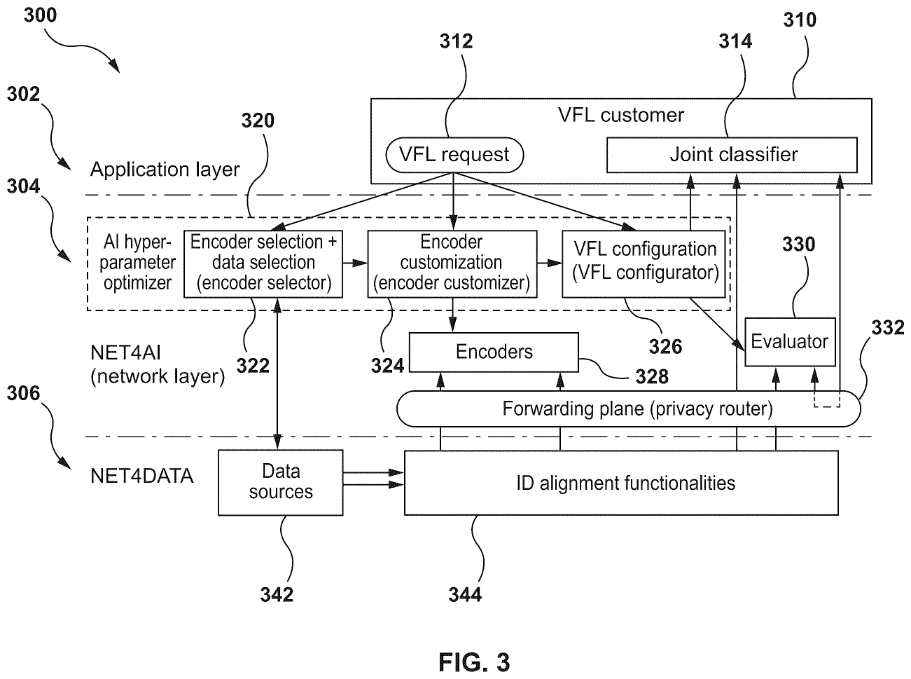

With reference to FIG. 3, there is depicted a non-limiting embodiment of an automated VFL architecture 300. In this embodiment, the automated VFL architecture 300 comprises an application layer 302, a network layer 304, and a data layer 306.

Broadly speaking, various layers of the automated VFL architecture 300 are part of a framework used to describe the functions of a networking system that implements VFL. Different layers can be used to characterize computing functions performed by one or more networking nodes (e.g., servers) for at least in part supporting interoperability between hardware and software components of the automated VFL structure 300.

In this embodiment, the application layer 302 comprises a VFL customer 310. However, the application layer 302 may comprise a plurality of VFL customers without departing from the scope of the present technology. In this embodiment, the VFL customer 310 maintains a joint classifier 314 and is configured to provide VFL requests, such as a VFL request 312, to components of the network later 304.

In this embodiment, the data layer 306 comprises a plurality of data sources 342 to be potentially used during automated VFL. ID alignment functionalities 344 may be enabled on the data layer 306. Broadly speaking, data source(s) may be configured as logical network entity storage for storing and/or maintaining the necessary raw data (as VFL model input) and labelled data (as benchmark to calculate the training loss) used for the present technology to train the VFL model. It is contemplated that the entire batch of raw data or labelled data required to train the VFL model may be provided by one or multiple data sources. In some embodiments, the data source can be either centrally deployed in a network entity or deployed in multiple distributed entities, without departing from the scope of the present technology.

In the illustrated non-limiting embodiment, the network layer 304 maintains an AI hyper-parameter optimizer 320, a plurality of encoders 328, an evaluator 330, and a privacy router 332 (a forwarding plane). In the context of the present technology, the AI hyper-parameter optimizer 320 is configured to execute one or more computer implemented procedures for enabling the following functionalities: an encoder and data selection, encoder customization, and VFL configuration. In the illustrated non-limiting embodiment, the AI hyper-parameter optimizer 320 comprises an encoder selector 322, an encoder customizer 324, and a VFL configurator 326 for enabling the above-listed functionalities, respectively. Components of the AI hyper-parameter optimizer 320 will now be described in turn.

### Encoder Selector

In the illustrated non-limiting embodiment, the encoder selector 322 is configured to receive the VFL request 312 from the VFL customer 310 via an interface (defined in NET4AI architecture, for example) between an application controller and a service manager. The VFL customer 310 can be said to be the user of the automated VFL who provides the VFL request 312 containing a VFL problem for the network layer 304 to address, and maintains its own joint classifier 314 to calculate the joint ML model output from the plurality of encoders 328. In some embodiments, the VFL customer 310 may be one of the VFL participants with its associated local encoder and dataset. In other embodiments, the VFL customer 310 may have no associated local encoder or dataset, and requests a joint model for solving one or more VFL problems, the VFL problem can be seen as VFL task.

In the illustrated non-limiting embodiment, the encoder selector 322 maps the VFL request 312 to data requirements and encoder structure requirements that may be necessary to solve the VFL problem described in the VFL request 312. The data requirements include indication of “must-contained” data features and labelled data requirements (e.g., minimal amount of labeled data, labeled data format, etc.) which may need to be provided by data sources of VFL participants. The data requirements indicate the requirements for selecting data source for solving the VFL problem.

The encoder requirements indicate the encoder structures which may be necessary to provide specific functionalities for solving a VFL problem. For example, given a problem described as “traffic violation recognition from surveillance video”, an indication of the encoder structure “CNN” may be provided for indicating that a CNN encoder must be included by the joint model to process the video data. The encoder selector 322 can interact with data source manager over multiple rounds of communications to complete the encoder and data source selection procedures. How the encoder and data selection procedure are implemented in some embodiments of the present technology will be described in greater detail herein further below.

### Encoder Customizer

In the illustrated non-limiting embodiment, when a set of encoders (with associated AI enablers) are selected for the VFL problem, the encoder customizer 324 is configured to “filter out” the overlapped data features for selected encoders, and can determine the customization parameters for each encoder. To calculate the customization parameters for respective encoders, the weights of respective data features in the input layer of the corresponding encoder may be determined by the encoder customizer 324. The calculation process requires interactions between the encoder customizer 324 and another AI enabler maintaining a trained encoder with a same structure as the corresponding encoder. In some cases, after implementing encoder customization on respective selected encoders, the corresponding AI enablers may feedback the customized encoder features to the encoder customizer 324, thereby completing the encoder customization procedure.

### VFL Configuration

In the illustrated non-limiting embodiment, when customized encoder features are provided by encoder customizer 324, the VFL configurator 326 configures parameters for the joint classifier 314 and the evaluator 330, as well as the routing rule for data exchanges amongst the joint classifier 314, evaluator 330 and the plurality of encoders 328. This configuration of parameters and router rule(s) is referred to herein as the VFL configuration procedure.

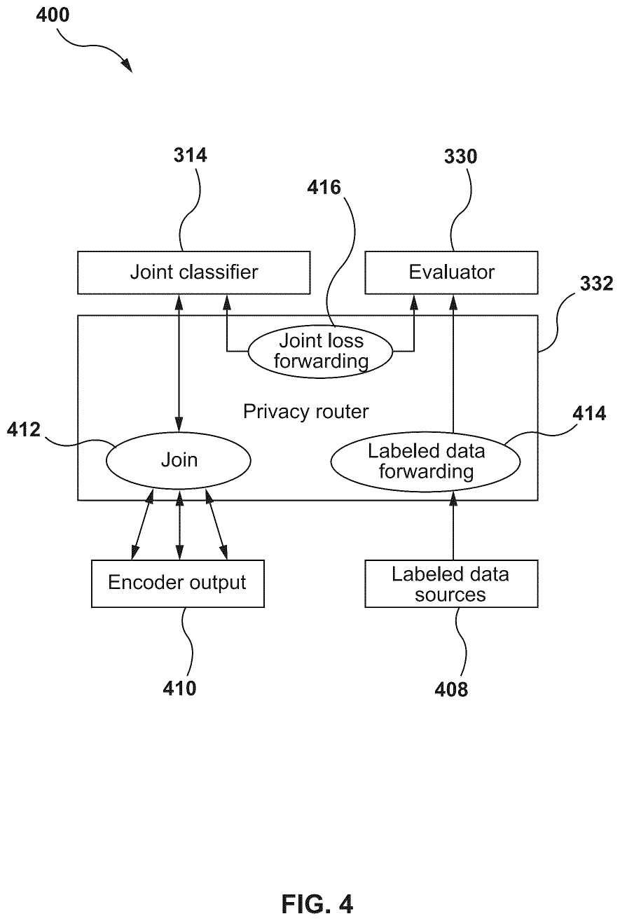

With reference to FIG. 4, the VFL configuration procedure involves the joint classifier 314, the evaluator 330, and the privacy router 332. In the illustrated non-limiting embodiment, the joint classifier 314 is implemented as a service function running by the third-party VFL customer 310 on an application server and/or by the network. The joint classifier 314 may perform functionalities of intermediate result exchange and collaborator defined in conventional VFL framework such as calculating outputs of the joint ML model from outputs of multiple selected VFL encoders, interacting with evaluator 330 to obtain joint loss, and backpropagating gradients for each encoder, for example.

In some non-limiting embodiments of the present technology, the joint classifier 314 may be pre-configured with a fixed structure. In these non-limiting embodiments, the VFL configurator 326 can configure encoder outputs to joint classifier 314 according to the customized encoder output-layer features.

In the illustrated non-limiting embodiment, the evaluator 330 is implemented as a service function running on the network layer 304. The evaluator 330 receives labelled data forwarded by the privacy router 332 from one or multiple data sources 308, and calculate the joint loss value by applying a specific loss function for comparing the joint ML model outputs from joint classifier 314 and the corresponding labelled data.

In some non-limiting embodiments, the VFL configurator 326 may configure the selected loss function, and the labelled data format (including the combination rule if the labelled data is comprised by data from multiple data sources) according to the labelled data information of selected encoders and data sources 308.

In the illustrated non-limiting embodiment, the privacy router 332 is a pre-defined NET4AI functionality. However, the privacy router 332 may be implemented as a pre-defined functionality of a different architecture, without departing from the scope of the present technology. In automated VFL, the privacy router 332 enables secure data exchanges amongst the joint classifier 314, the evaluator 330, selected encoders, and labelled data sources 308.

In the illustrated non-limiting embodiment, a data join function 412 can be executed by the privacy router 332 for concatenating unbalanced data entities (e.g., in terms of data entity amount) associated with the same data ID during the training phase. The data joint function 412 can provide interface between encoder outputs 410 and the joint classifier 314. Broadly speaking, the data join function 412 combines multiple outputs (each output may be in form of a batch of data) from different encoders into a single batch of joint output according to pre-defined combination rules (e.g., concatenate all output batches into one), then send to the joint classifier 314 for further training/inference. The privacy router 332 can also perform joint loss forwarding 416 between the joint classifier 314 and the evaluator 330, and labelled data forwarding 414 from labelled data sources 408 to the evaluator 330.

Various embodiments of the present technology which may be instrumental in enabling at least some of encoder and data selection functionalities, encoder customization functionalities, and VFL configuration functionalities of an automated VFL architecture will now be described.

### Encoder and Data Selection Embodiment

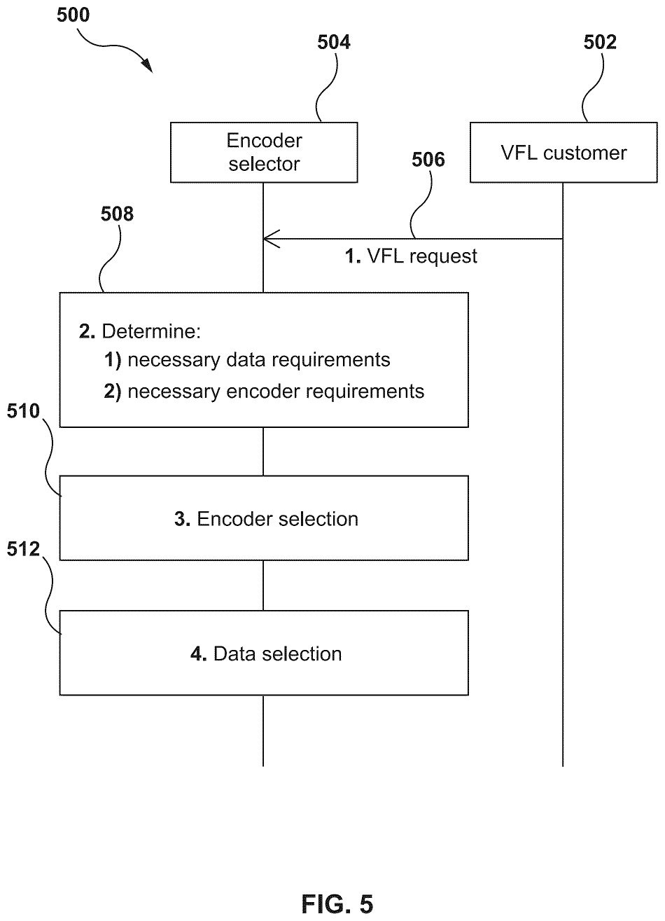

With reference to FIG. 5, there is depicted a schematic representation of the encoder and data selection procedure 500. In the illustrated non-limiting embodiment, the procedure begins at step 506 where the encoder selector 504 receives a VFL request 506 from a VFL customer 502. It is contemplated that the VFL request 506 may be received by the encoder selector 504 similarly to how the VFL request 312 is received by the encoder selector 322, without departing from the scope of the present technology. As mentioned above, the VFL request 506 contains a description of VFL problem to be solved/train the VFL for solving.

Broadly, the VFL problem is a general problem which can be “understood” by the encoder selector 504 to determine specific data requirements and/or encoder requirements. In those embodiments where the VFL customer 502 has partial and/or full knowledge of the detailed data requirements and encoder requirements, the VFL customer 502 can directly indicate them in the VFL request 506 for encoder selector 504 to process.

In other embodiments where VFL customer 502 only provides a general VFL problem in the VFL request 506, the procedure may continue to step 508 for determining data requirements and encoder requirements. To that end, the encoder selector 504 decouples or splits the VFL task into sub-tasks. As an example, the sub-tasks includes a first sub-task and a second sub-task. It can be understood, the quantities of sub-tasks can be more than two.

Performing a given sub-task requires a list of necessary data features and requirements for labeled data (e.g., amount, content or data and the like), which is referred to herein below as the necessary data requirements for the sub-task. Each sub-task also corresponds to an application category which is associated with a specific encoder structure, which is referent to as necessary encoder requirement for the sub-task.

For example, a VFL task “traffic violation recognition” can be broken down into a combination of following sub-task: 1) Sub-task to recognize traffic violation by camera records, which requires video stream data features and labeled traffic violation video clips (necessary data requirements) and CNN encoder for video processing (necessary encoder requirement); 2) Sub-task to recognize traffic violation by RSU data, which requires RSU sensed data features and labeled data and encoder structure for RSU data processing. It should be noted that the application category can be a pre-defined NET4AI concept, for example, which describes a set of applications/problems that can be solved by a specific encoder structure. Hence, it can be said that an encoder structure may be stored in association with a respective application category.

In some embodiments, the VFL task can be implemented as a list of attributes representing the sub-task IDs and their importance (weights). Composition and attribute values for each VFL task can be maintained by the encoder selector 504 and learned from historical data and/or pre-existing knowledge. In the previous example with a “traffic violation recognition” task, the VFL task may be defined as [(1, 0.4); (2, 0.6)], in which (1, 0.4) corresponds to the “camera record” sub-task with ID equals “1” and importance equals “0.4”, and in which (2, 0.6) corresponds to the “RSU” sub-task with ID equals “2” and importance equals “0.6”.

In this embodiment, the procedure continues to step 508 with the encoder selector 504 selecting of one or more encoders for solving the VFL task, the one or more encoders can be selected from a pool of encoders in the communication network. Since a given encoder structure corresponds to one application category the encoder selector 504 may select encoders for participation in VFL according to the necessary encoder requirements of the plurality of sub-tasks. The quantities of encoders can be consistent with the quantities of the sub-tasks. When the sub-tasks includes the first sub-task and the second sub-task, the encoder requirements indicates a first encoder structure to be used for solving the first sub-task and a second encoder structure to be used for solving the second sub-task.

In some embodiments, the encoder selector 504 may select encoders with comparatively simpler structures to fasten the convergence speed of joint model training for ensuring a pre-determined effective threshold (e.g., classification/prediction accuracy).

In other embodiments, the encoder selector 504 may need to ensure that the set of selected encoders includes necessary encoder structures required to solve all sub-tasks of the VFL task. For example, in the previously presented “traffic violation recognition” task, the set of selected encoders may need to comprise at least a CNN to solve “camera record” sub-task, and a DNN to solve the “RSU data” sub-task. the CNN can be seen as the first encoder and the DNN can be seen as the second encoder. the first encoder configured to process a first set of features for solving the first sub-task, the second encoder configured to process a second set of features for solving the second sub-task.

In the illustrated non-limiting embodiment, the procedure continues to step 510 with selection of data to be used for solving the VFL task. Given the selected encoders of the step 508, the encoder selector 504 is configured to determine data sources for each selected encoder. The encoder selector 504 is configured to select the first data source for solving the first sub-task from a pool of data sources, the first data source comprises a first set of features, and to select the second data source for solving the second sub-task from a pool of data sources, the second data source comprises a second set of features.

In those embodiments where all data sources are owned by the network, the encoder selector 504 can directly execute the data selection process according to full information of all available data sources. In other embodiments, however, where available data sources are not owned by the network, the encoder selector 504 may interact with a Data Source Manager to access the information of available data sources (including data source locations, data qualities, data features can be provided for each data source, etc.) for data selection.

For example, the data source manager may be a data analytics and management (DAM) function or entity that aims to monitor data sources, and provides data analyze functions for different network applications (including the VFL application).

In this example, the data selection process can be completed by the following set of interactions between the data source manager and the encoder selector 504. A first interaction may include the encoder selector 504 sending all necessary data requirements to the data source manager to request available data source information, the data requirement are included in a request sent by the encoder selector 504 to the data source manager. A second interaction may include the data source manager feeding back data quality and data features information of all available data sources in the pool of data sources.

In response to the received available data source information, the encoder selector 504 may select detailed data sources for each selected encoder, and the data sources for labelled data. During data source selection, the encoder selector 504 may need to ensure that (i) the set of selected data sources provides all necessary data features required by sub-tasks, (ii) the selected data sources have a minimal number of overlapped features, and (iii) the labelled data may be original labelled data from one or multiple selected sources, or joint labelled data comprised by labelled data with partial features from multiple data sources.

In this example, a third interaction may include the encoder selector 504 sending all selected data source IDs to the DAM tool. A fourth interaction may include the DAM tool feeding back the locations of all datasets that include the selected data sources. It should be noted that each data source may be hosted partially by multiple datasets at different network locations (e.g., severs, edge devices, and the like). In response to receipt of detailed dataset locations, the encoder selector 504 may determine the location to implement the corresponding encoder (AI enabler location) which minimize the communication cost between datasets and the AI enabler.

### Encoder Customization Embodiment

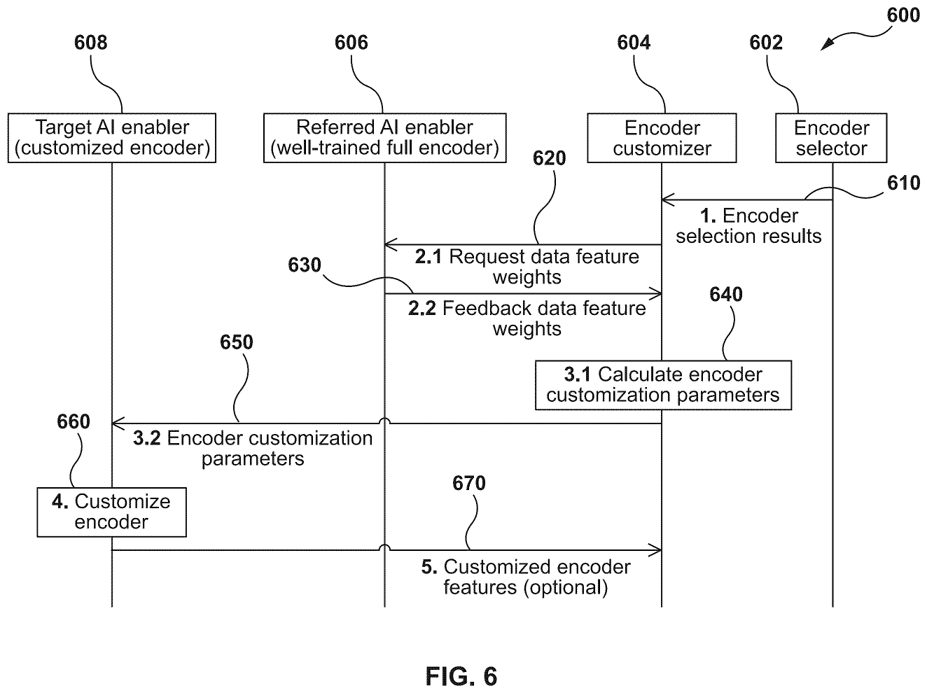

With reference to FIG. 6, there is depicted a schematic diagram of an encoder customization procedure 600. The customization procedure 600 can involve communication and data transfer between an encoder selector 602, an encoder customizer 604, a referred AI enabler 606 and a target AI enabler 608. The encoder selector 602 may be implemented in a similar manner to the encoder selector 322 of FIG. 3 and/or the encoder selector 504 of FIG. 5. The encoder customizer 604 may be implemented in a similar manner to the encoder customizer 324 of FIG. 3. The referred AI enabler 606 is a well-trained “full” encoder that is available on the network. The target AI enabler 608 is an encoder that is to be “customized” in accordance with at least some embodiments of the present technology.

At step 610, the encoder selector 602 sends encoder selection results to the encoder customizer 604. For example, the step 610 may occur after the completion of an encoder and data selection procedure as mentioned above. In some embodiments, the customization procedure 600 may be triggered by the encoder customizer 604 in response to receipt of the encoder selection results.

The content of the encoder selection results are not limited and may vary depending on inter alia various implementations of the present technology. However, in some embodiments the contents of encoder selection result includes: encoder structure parameters of a respective selected encoder (e.g., number of layers, size, etc.), location of a target AI enabler (TE) that will implement a respective customized selected encoder, and location of a Referred AI enabler (RE) that implements a respective well-trained selected encoder.

In the illustrated non-limiting embodiment illustrated in FIG. 6, the encoder selection results comprise inter alia encoder structure parameters of a first encoder for a first sub-task, a location of the corresponding TE 608, and a location of the corresponding RE 606.

Without wishing to be bound to any specific theory, developers have realized that the purpose of involving RE 606 in the encoder customization procedure 600 is to calculate different weights of data features in a given selected encoder, which may be required parameters for executing a customization decision. It is contemplated that the data features for which the weights are to be calculated by the RE 606 are data features originating from the first data source. In at least one case, since all AI enablers for different applications can all be maintained by a network layer (e.g., NET4AI network), an encoder selector can directly select the most trained RE 606. However, to ensure the security and privacy requirements, the encoder selector only “knows” the encoder structure in the RE 606 (same as the selector encoder structure), and how well the encoder is trained (e.g., number of training/usages). Detailed values (bias/weights) of neurons and links in the RE 606 are not per se known by the encoder selector.

Continuing with the description of FIG. 6, at step 620 the encoder customizer 604 sends a request to the corresponding RE 606 for data feature weights. At step 630, the encoder customizer 604 receives calculated data feature weights. It should be noted that for a given encoder, the weight of each data feature in its input layer indicates the impact/importance of the corresponding data feature to the output of the given encoder. For example, the higher the weight of a given data feature, the more significant variations of the encoder outputs can be observed when changing the given data feature value.

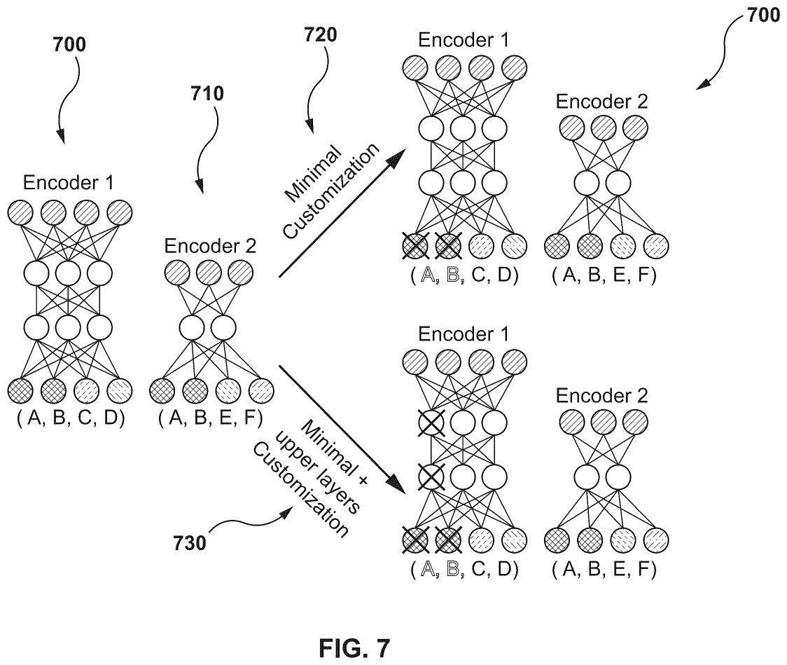

With reference to FIG. 7, there is depicted an example of structures of a first encoder 700 and a second encoder 710 that have been selected by the encoder and data selection procedure. For example, the first encoder 700 has input data features (A,B,C,D) with weight (0.3, 0.4, 0.1, 0.2) and the second encoder 710 has input data feature (A,B,E,F) with weight (0.1, 0.2, 0.4, 0.3). In this example, the input data features (A,B,C,D) originate from the first data source and the input data features (A,B,E,F) originate from the second data source.

Developers of the present technology have realized that there are multiple ways to calculate the weight of respective data features for a customized encoder according to the well-trained encoder. However, the encoder customizer 604 may be unable to access the well-trained values of neurons and links in the corresponding RE 606 due to security and privacy requirements. Therefore, the calculation of respective data feature weights of a given selected encoder can be completed via interactions between encoder customizer 604 and the corresponding RE 606 performed during the steps 620 and 630. As such, the encoder customizer 604 sends the request to the corresponding RE 606 for data feature weights (step 620), and the corresponding RE 606 calculates the data feature weights locally according to known techniques, for example, and then feedbacks the calculated data feature weights to the encoder customizer 604 (step 630). As an example, the calculated data feature weights comprises data features weights corresponding to each feature in the first set of features and data features weights corresponding to each feature in the second set of features, the first set of features are included in the first data source for the first encoder, and the second set of features are included in the second data source for the second encoder. At least one of such technique is disclosed in an article entitled “Problems with Shapley-value-based explanations as feature importance measures”, authored by Kumar, I. Elizabeth, et al., and published on 30 Jun. 2020, the content of which is incorporated herein by reference in its entirety. Other techniques are also contemplated without departing from the scope of the present technology.

The customization procedure 600 continues to step 640 at which encoder customization parameters are calculated by the encoder customizer 604 given the calculated data feature weights of all selected encoders by the corresponding RE 606, the encoder customizer 604 is configured to select “prime features” for the joint model being built.

In some embodiments, non-overlapped data features may be automatically selected as the prime features. Broadly speaking, non-overlapped data features include data features that exist in its respective selected encoder, without existing in an other selected encoder. In the example illustrated in FIG. 7, non-overlapped features include features C,D,E,F.

In other embodiments, for a given overlapped data feature, the encoder customizer 604 compares its data features weights in respective selected encoders and selects the one with highest relative weight as a prime feature. Broadly speaking, overlapped data features include data features that are duplicated in at least two selected encoders. In the example illustrated in FIG. 7, overlapped features include features A,B.

For example, it can be noted that in the first encoder 700 features A and B are prime features. The relative weights are different from the data feature weights calculated by REs. Relative weights calculation considers both data feature weights of each REs and other factors such as, but not limited to: encoder structure size (high size means high complexity which affects the output convergence performance), dependency with other features, and overall importance of the feature. It should be noted that the relative weights are used for determining which data features are to remain, and which data features are to be deleted, in the first encoder 700 and the second encoder 710. In this example, it can be said that the relative weights are used for determining whether the features A and B are to be deleted from the first encoder 700 or the second encoder 710. Given the selected prime features, all non-prime data features are deleted by the encoder customizer from corresponding selected encoders. By deleting the non-prime features, the side-effects to the joint model caused by overlapped data features can be effectively alleviated.

In some embodiments of the present technology, three modes of encoder customization can be selectively performed by the encoder selector 602 depending on inter alia different application scenarios. For example, a first mode 720 can be referred to as a minimal customization mode in which only input layer neurons corresponding to non-prime features in selected encoders are deleted. This is an encoder customization mode with least impacts to the joint model structure.

In another example, a second mode can be referred to as a weight-based customization mode 730 in which, for a given selected encoder with non-prime features deleted from its input layer, the encoder customizer 604 sends deleted neurons' ID to the corresponding RE with corresponding well-trained encoder. The corresponding RE deletes all neurons and links in the encoder which are highly impacted by the deleted features. The impacts of each data feature to the specific neuron or link in an encoder can be calculated according to various techniques. At least one such technique is disclosed in the article entitled “Problems with Shapley-value-based explanations as feature importance measures” mentioned above. Then, the corresponding RE feedbacks the deleted neurons and links ID/location to the encoder customizer 604 to complete the customization of the encoder.

In a further example, a third mode can be referred to as a learning-based customization mode in which, for a given selected encoder with non-prime features deleted from its input layer, the encoder customizer 604 applies learning based NN pruning solution to train a customized encoder. At least one such solution is disclosed in an article entitled “Learning both Weights and Connections for Efficient Neural Network”, authored by Han, Song et al., published in 2015, the content of which is incorporated herein by reference in its entirety.

Developers have realized that such a solution requires substantial computational resources during training. It should be noted that the training phase should be done by the corresponding TE implementing the customized encoder to reduce the computing cost of executing the encoder customizer 604.

In the illustrated non-limiting embodiment, at step 650 the encoder customizer 604 sends the encoder customization parameters to the corresponding TE 608 for executing the encoder customization decision process. The contents of encoder customization parameters may depend on inter alia different encoder customization modes. For the minimal customization mode 720, information indicative of deleted input layer neurons (non-prime features) may be included in the encoder customization parameters. For the weight-based customization mode 730, information indicative of deleted neurons and links for the full encoder may be included in the encoder customization parameters. For the learning-based customization mode, information indicative of deleted neurons in input layer and hyper-parameters for customization training may be included in the encoder customization parameters. It is contemplated that in some embodiments of the present technology, the hyper-parameters may include a loss threshold to determine convergence, weight thresholds for neurons and links to be deleted, and the like.

In the illustrated non-limiting embodiment, at step 660 the corresponding TE 608 implements the encoder customization decision according to received encoder customization parameters of the step 650. It is contemplated that the decision may be performed based on the relative weights. The relative weights can be computed based on the encoder customization parameters received at step 650. For minimal and weight-based customization modes 720 and 730, the corresponding TE 608 can directly delete corresponding neurons and/or links. For learning based customization mode, the corresponding TE 608 may run the customization training until convergence, without departing from the scope of the present technology. Customization training can be triggered in response to receipt of the encoder customization parameters.

For illustration only, let it be assumed that the corresponding TE 608 implements encoder customization decision according to the learning-based customization mode. In the illustrated non-limiting embodiment, since the final customization results of learning-based customization are obtained at the corresponding TE 608, after reaching convergence, the corresponding TE 608 may feedback at step 660 the customized encoder features (e.g., customized structure of the encoder) to encoder customizer 604. The customized encoder features may be used for further VFL configuration, for example.

### VFL Configuration Embodiment

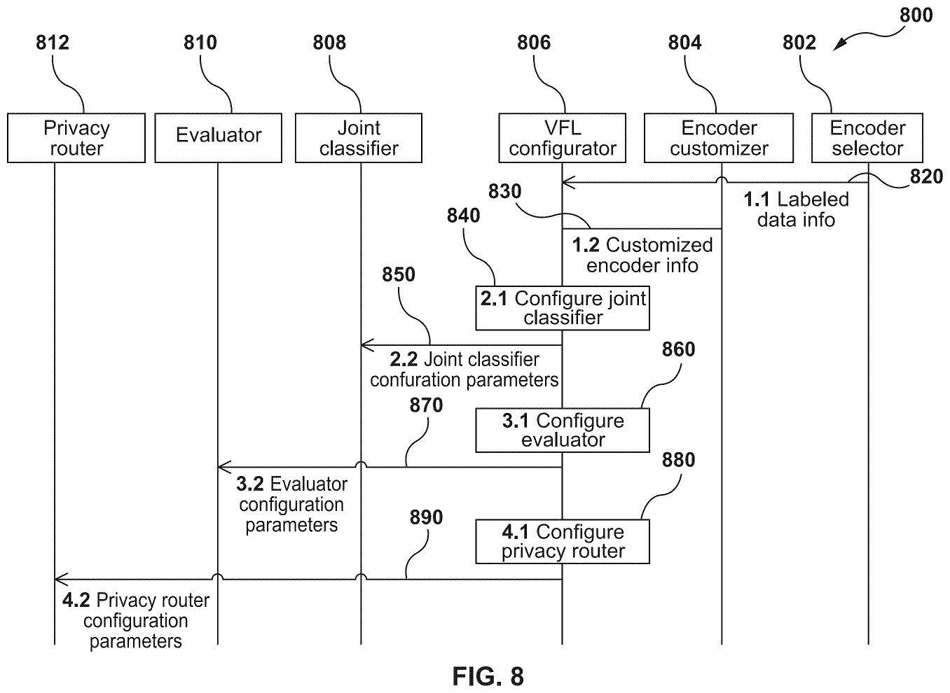

With reference to FIG. 8, there is depicted a schematic representation of a VFL configuration procedure 800. The VFL configuration procedure 800 involves an encoder selector 802, an encoder customizer 804, a VFL configurator 806, a joint classifier 808, an evaluator 810, and an privacy router 332. It is contemplated that at least some components involved in the VFL configuration procedure 800 may be implemented in a similar manner to components of the VFL architecture 300 depicted in FIG. 3, without departing from the scope of the present technology.

In the illustrated non-limiting embodiment, at step 820 the encoder selector 802 sends labelled data information to the VFL configurator 806 and at step 830 the encoder customizer 804 sends customized encoder information to the VFL configurator 806. In some embodiments, receipt of the labelled data information and the customized encoder information by the VFL configurator 806 may trigger following steps of the VFL configuration procedure 800.

Broadly, the labelled data information includes the locations and provided data features of datasets that comprise the labelled data source(s). In other words, the labelled data information is indicative of locations (which part of labelled data comes from which data sources amongst the first data source and the second data source), as well as how the labelled data is to be combined. It is contemplated that the loss function indicated by a VFL customer may also be transmitted as part of the labelled data information. The customized encoder information includes information indicative of an output layer structure of a respective customized encoder. As an example, when the encoder customizer 804 determine the first encoder need to be customized according to data feature weights, the customized encoder information includes information indicative of an output layer structure of the customized first encoder. When the encoder customizer 804 determine the first encoder and the second encoder need to be customized according to data feature weights, the customized encoder information includes information indicative of an output layer structure of the customized first encoder and the customized second encoder.

In the illustrated non-limiting embodiment, at step 840 the VFL configurator 806 configures encoder outputs to the joint classifier based on the customized encoder information. Configuration of encoder outputs to the joint classifier may be performed in a variety of ways. In some embodiments, output layers of multiple encoders may be connected to input layer of the joint classifier via concatenation of the output layers of multiple encoders. At least one other connection mode is disclosed in an article entitled “SplitNN-driven vertical partitioning”, authored by Iker Ceballos et al., published on 7 Aug. 2020, the content of which is incorporated herein by reference in its entirety.

In the illustrated non-limiting embodiment, at step 850 the VFL configurator 806 sends joint classifier configuration parameters to the joint classifier 808. The contents of the joint classifier configuration parameters are used by the joint classifier to customize or modify its local configurations to match the outputs of the encoders (which are inputs of the joint classifier). For example, in some embodiments, the encoders that are customized in a weight-based way or learning-based way, as mentioned above, may have their output layer neurons been partially muted and/or deleted. The VFL configurator may put the info of muted output-layer neurons (e.g., of all encoders) into the joint classifier configuration parameters. By receiving the joint classifier configuration parameters, the joint classifier can customize its input layer architecture (e.g., by muting and/or deleting neurons) to match the encoder outputs.

In the illustrated non-limiting embodiment, at step 860 the VFL configurator 806 configures the evaluator 810. As part of the step 860, the VFL configurator 806 configures, using the labelled data information, a combination rule of partially labelled data from different datasets when they are merged in the evaluator 810. Also as part of the step 860, the VFL configurator 806 configures the loss function to be used during VFL.

It is contemplated that partially labeled data can be said to be labeled data whose associated label info does not represent the completed label info. All partially labeled data associated with the same ID/sample should be combined together to form the completed labeled data. For example, a completed labeled data may be represented as “[A, blue cat]” where “A” is the associated ID/sample (i.e., the represented entity), and where “blue cat” is the label. In some embodiments, this labeled data may provided from two different data sources, one data source that provides “[A, blue]”, and the other provides “[A, cat]”. In this example, both “[A, blue]” and “[A, cat]” are named as partially labeled data.

In the illustrated non-limiting embodiment, at step 880 the VFL configurator 806 configures the inter-encoder, or “privacy”, router 812. It is contemplated that the privacy router 812 may be implemented similarly to the privacy router 332 in FIG. 3. As part of the step 880, the VFL configurator 806 configures the routing routes of data transmission for (i) data exchange route between the joint classifier 808 and the evaluator 810, (ii) labelled data merge routes between the evaluator 810 and respective data sources, and (iii) backpropagation routes between the joint classifier 808 and respective encoders for back propagating gradient values. The “respective encoders” in (iii) can be understood as: all the selected encoders selected by the encoder selector. when some of the selected encoders are customized by the encoder customizer, then the “respective encoders” in (iii) includes the customized encoders and the other remained encoders which are not customized in all the selected encoders. when the selected encoders selected by the encoder selector include the first encoder and the second encoder, and the first encoder is customized, then the “respective encoders” in (iii) includes the customized first encoder and the second encoder.

In the illustrated non-limiting embodiment, at step 890 the VFL configurator 806 sends privacy router configuration parameters to the privacy router 812. It is contemplated that the routes supported by the privacy router 812 in at least some embodiments of the present technology are discussed above with reference to FIG. 4.

### Performance Evaluation

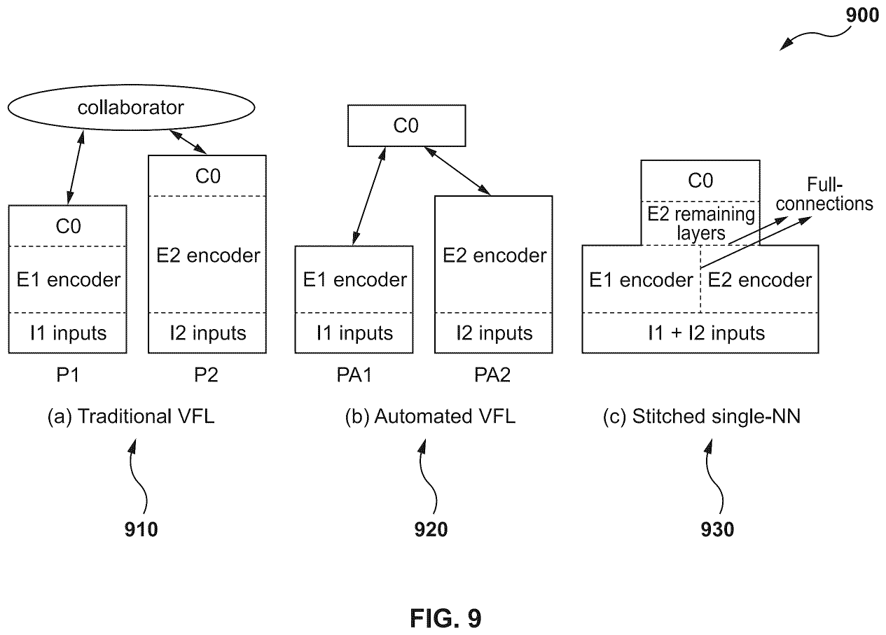

With reference to FIG. 9, there is depicted three simplified representations of VFL frameworks. To validate the effectiveness and efficiency of an automated VFL architecture at contemplated in at least some embodiments of the present technology, simulations have been performed to compare the performance of three cases in terms of binary classification tasks—that is, traditional VFL 910, an automated VFL 920, and a stitched single-NN 930.

Broadly, the traditional VFL 910 includes two participants (P1 and P2) with different encoders (E1 and E2). Detailed parameters for E1 and E2 are shown in Table 1 below. Both participants have independent classifiers with the same structure (C0). The inputs of both participants (I1 and I2) are fully overlapped in ID space, and partially overlapped in feature space. The automated VFL 920 includes two participants (PA1 and PA2) with the encoder and input parts of P1 and P2. The outputs of the two participants are concatenated to a joint classifier which has the same structure as C0. It should be noted that all classifiers used in these three cases are identical in terms of structure. The stitched single-NN 930 concatenates I1 and I2 as an integrated input layer, and stitches E1 and E2 layer by layer with full-connections to form a stitched encoder. It should be noted that the remaining hidden layers of the encoders (e.g., E2 remaining layers) are fully connected to the stitched structure. The independent classifier C0 is fully connected to the output layers of the stitched encoder.

TABLE 1
Simulation parameters

| Simulation parameters | Values |
|---|---|
| El structure (neurons in each layer) | [32, 64] |
| E2 structure (neurons in each layer) | [8, 16, 16] |
| C0 structure (neurons in each layer) | [8, 2 (with softmax)] |
| Activation function | SELU |
| Number of epochs | 100 |
| Batch size | 32 |
| Learning rate | 1e−3 |

In the simulation, experiments have been conducted on two datasets, i.e., an anonymous bank dataset containing the user information of a German bank (Germanbank), and a network traffic dataset used for deep-packet-inspecting of encrypted Internet traffic (TLS22).

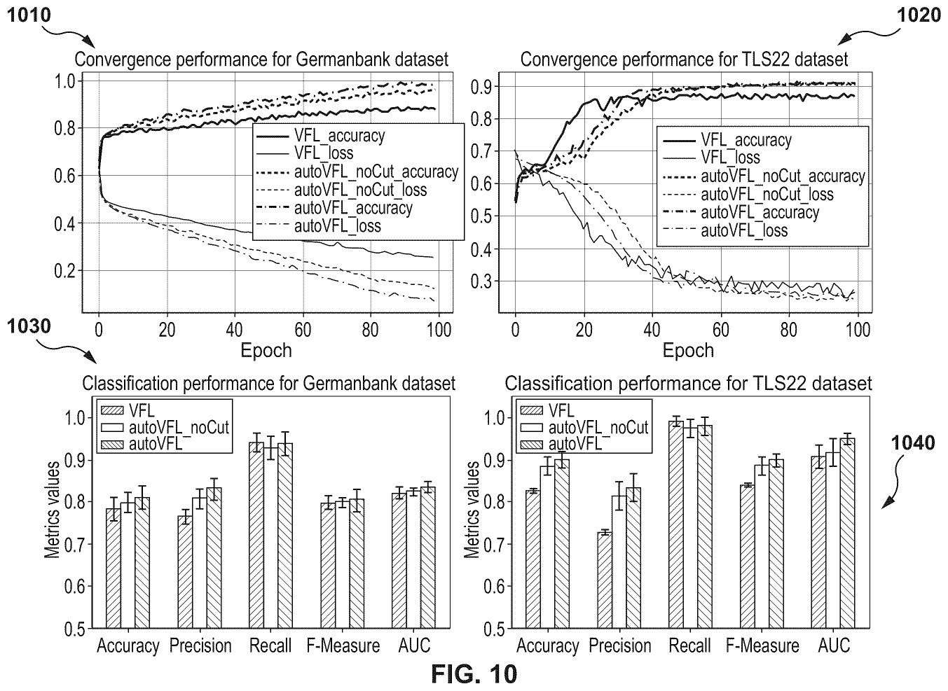

With reference to FIG. 10, there is depicted a performance comparison between traditional VFL 910 and automated VFL 920 applied to the two test datasets mentioned above. To validate the effectiveness of encoder customization as contemplated in at least some embodiments of the present technology, both the automated VFL without applying encoder customization “autoVFL_noCut”, and the automated VFL applying minimal encoder customization “autoVFL” have been simulated. As illustrated on graphs 1010 and 1030, it can be seen that the automated VFL 920 (with or without encoder customization) can converge to better optimal results with higher accuracy and lower variations when compared with the traditional VFL 910, in some implementations of the present technology. As illustrated on graphs 1020 and 1040, classification performance of traditional VFL 910 and the automated VFL 920 is compared. It can be said that the automated VFL 920 can improve general performance metrics when compared with traditional VFL 910, especially on accuracy (5%-8% improvement) and precision (10% improvement), in at least some implementations of the present technology.

Developers have realized that a better performance achieved by automated VFL, in at least some embodiments of the present technology, can be enabled by two aspects of the automated VFL. Firstly, compared to the intermediate result exchange a traditional VFL, the joint classifier can enable more intensive mutual-impact among participated encoders, which enhances the efficiency of training the joint model. Secondly, the encoder customization can further reduce negative effects caused by overlapped data features from inputs of multiple participants. Although both joint classifier and encoder customization can improve overall performance, the joint classifier has higher influence than the encoder customization according to the results shown in FIG. 10. Furthermore, it should be noted that only the minimal encoder customization mode has been applied in simulations of FIG. 10. When more complex encoder customization algorithms are fully implemented (other modes described herein above), the encoder customization may increase performance of the automated VFL, without departing from the scope of the present technology.

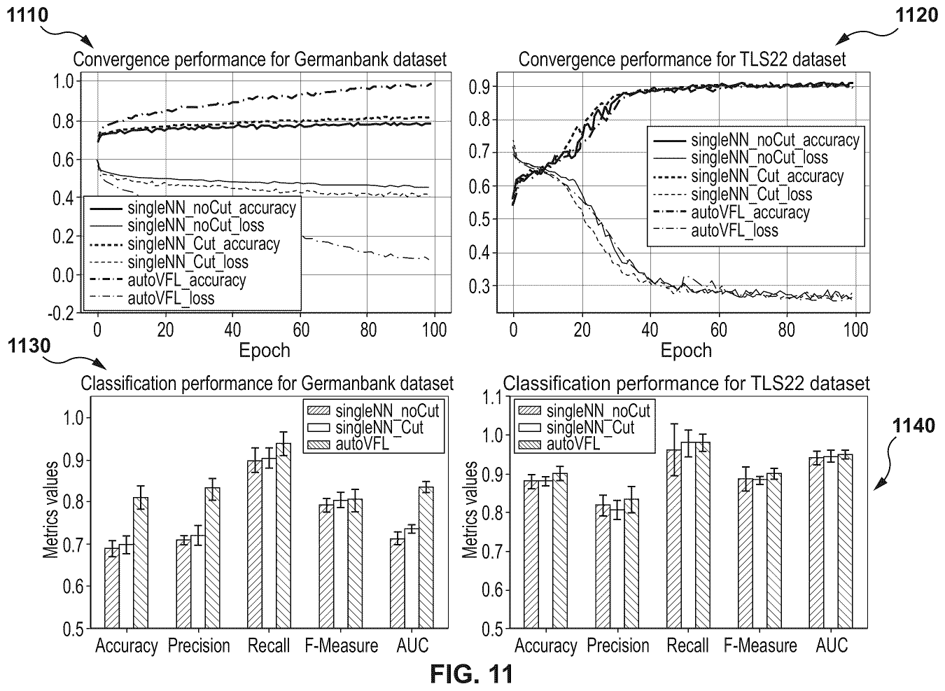

With reference to FIG. 11, there is depicted a performance comparison between the automated VFL 920 and the stitched single-NN 930 applied to the two test datasets mentioned above. For the stitched single-NN 930, both the single-NN without applying encoder customization on its concatenated input layer “singleNN_noCut”, and the single-NN applying minimal encoder customization on its concatenated input layer “singleNN_cut” have been simulated. It is contemplated that the automated VFL can achieve comparable convergence and classification performance without significant loss than that of the stitched single-NN, in at least some embodiments of the present technology. Furthermore, as seen on graphs 1110 and 1120, it can be noted that the stitched single-NN 930 causes significant performance drawbacks since the simple stitched NN structure may not suitable for the specific dataset or problem. Although an appropriate new NN can reduce these drawbacks, developers have realized that the re-designing procedure for the new NN can be costly because no clear design principles are available, and no existing model can be reused. Therefore, it can be said that the automated VFL 920 may achieve comparable or better general performance metrics than the stitched single-NN 930, in at least some implementations of the present technology.

In some embodiments of the present technology, there is provided an automated VFL system which is configured to perform at least some of the following functionalities: an encoder selector, encoder customizer, VFL configurator and joint classifier. The automated VFL system can be implemented for the NET4AI architecture, in some implementations of the present technology.

In some embodiments, the automated VFL system may achieve better AI model performance compared to traditional VFL and stitched single NN because (i) joint classifier can enable deep mutual-impact among participated encoders (compared with traditional VFL), and (ii) encoder customization can reduce negative effects caused by overlapped data features. In other embodiments, the automated VFL system may enable automated encoder selection and reuse. As a result, this allows reusing existing encoders in network to solve VFL task, and a specific NN for that purpose may not need to be designed. No need to design specific NN. Both encoder (and dataset) selection and customization are automated by NET4AI. Also, this may avoid VFL configurations through application layer, and as a result no VFL management overhead at application layer may be required. In further embodiments, the automated VFL system may solve complex tasks by supporting loss functions violating homomorphic encryption and allow labeled data to be separately provided by multiple data sources.

Those of ordinary skill in the art will realize that the description of various embodiments are illustrative only and are not intended to be in any way limiting. Other embodiments will readily suggest themselves to such persons with ordinary skill in the art having the benefit of the present disclosure. Furthermore, at least some of the disclosed embodiments may be customized to offer valuable solutions to existing needs and problems related to VFL. In the interest of clarity, not all of the routine features of the implementations of the at least some of the disclosed embodiments are shown and described.

In particular, combinations of features are not limited to those presented in the foregoing description as combinations of elements listed in the appended claims form an integral part of the present disclosure. It will, of course, be appreciated that in the development of any such actual implementation of the at least some of the disclosed embodiments, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of feedback equalization at high-data rates having the benefit of the present disclosure.

In accordance with the present disclosure, the components, process operations, and/or data structures described in herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer, a processor operatively connected to a memory, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory of servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A method comprising:
receiving, by an encoder selector, a Vertical Federated Learning (VFL) request from a VFL customer;
determining, by the encoder selector, data requirements and encoder requirements for solving a VFL task according to the VFL request,
the VFL task being splittable into a plurality of sub-tasks, the plurality of sub-tasks at least including a first sub-task and a second sub-task;
selecting, by the encoder selector based on the encoder requirements, a first encoder and a second encoder being from a pool of encoders in a communication network,
the first encoder configured to process a first set of features for solving the first sub-task, the second encoder configured to process a second set of features for solving the second sub-task; and
selecting, by the encoder selector based on the data requirements, a first data source for the first encoder and a second for the second encoder, the selected data sources being from a pool of data sources, the first data source comprising the first set of features, and the second data source comprising the second set of features.

2. The method of claim 1, wherein the method further comprises splitting, by the encoder selector, the VFL task into the plurality of sub-tasks.

3. The method of claim 1, wherein the selecting the first encoder comprises:
determining, by the encoder selector, an application category of the first sub-task based on the encoder requirements,
the application category being stored in a memory in association with the first encoder.

4. The method of claim 1, wherein the selecting the first encoder comprises:
identifying, by the encoder selector, the pool of encoders that has a first encoder structure; and
selecting, by the encoder selector, the first encoder from the pool of encoders that has the first encoder structure.

5. The method of claim 1, wherein the selecting the first data source and the second data source comprises:
sending, by the encoder selector to a data source manager, a request for data source information, the request including the data requirements;
receiving, by the encoder selector from the data source manager, the data source information indicative of quality of and features of data included in respective ones from the pool of data sources; and
selecting, by the encoder selector using the data source information, the first data source for the first encoder and the second data source for the second encoder.

6. The method of claim 5, wherein the first data source and the second data source are associated with respective IDs, the method further comprising:
sending, by the encoder selector to the data source manager, the respective IDs of the first data source and the second data source; and
receiving, by the encoder selector from the data source manager, network locations of the first data source and the second data source.

7. A method comprising:
receiving, by an encoder selector, a Vertical Federated Learning (VFL) request from a VFL customer;
determining, by the encoder selector, data requirements and encoder requirements for solving a VFL task according to the VFL request,
the VFL task being splittable into a plurality of sub-tasks, the plurality of sub-tasks at least including a first sub-task and a second sub-task;
selecting, by the encoder selector based on the encoder requirements, a first encoder and a second encoder being from a pool of encoders in a communication network,
the first encoder configured to process a first set of features for solving the first sub-task, the second encoder configured to process a second set of features for solving the second sub-task;
selecting, by the encoder selector based on the data requirements, a first data source for the first encoder and a second for the second encoder, the selected data sources being from a pool of data sources, the first data source comprising the first set of features, and the second data source comprising the second set of features;
customizing, by an encoder customizer, a first encoder by muting a portion of the first encoder, thereby generating a customized encoder;
configuring, by a VFL configurator, at least one of an evaluator and a joint classifier; and
configuring, by the VFL configurator, a privacy router to determine at least one of:
data exchange routes between the joint classifier and the evaluator,
labelled data merging routes between the evaluator and one or more of the selected data sources, and
backpropagation routes between the joint classifier and each one of a customized first encoder and a second encoder for back-propagating gradient values, wherein
the joint classifier, the evaluator and the privacy router configured for performing VFL.

8. The method of claim 7, wherein the method further comprises splitting, by the encoder selector, the VFL task into the plurality of sub-tasks.

9. The method of claim 7, wherein the selecting the first encoder comprises:
determining, by the encoder selector, an application category of the first sub-task based on the encoder requirements,
the application category being stored in a memory in association with the first encoder.

10. The method of claim 7, wherein the selecting the first encoder comprises:
identifying, by the encoder selector, the pool of encoders that has a first encoder structure; and
selecting, by the encoder selector, the first encoder from the pool of encoders that has the first encoder structure.

11. The method of claim 7, wherein the selecting the first data source and the second data source comprises:
sending, by the encoder selector to a data source manager, a request for data source information, the request including the data requirements;
receiving, by the encoder selector from the data source manager, the data source information indicative of quality of and features of data included in respective ones from the pool of data sources; and
selecting, by the encoder selector using the data source information, the first data source for the first encoder and the second data source for the second encoder.

12. The method of claim 11, wherein the first data source and the second data source are associated with respective IDs, the method further comprising:
sending, by the encoder selector to the data source manager, the respective IDs of the first data source and the second data source; and
receiving, by the encoder selector from the data source manager, network locations of the first data source and the second data source.

13. The method of claim 7, wherein the customizing includes:
determining overlapping features between the first set of features and the second set of features; and
muting the portion of the first encoder that processes the overlapping features.

14. The method of claim 7, wherein the customizing including:
determining, by the encoder customizer, that the first encoder is to be customized.

15. The method of claim 14, wherein the determining, by the encoder customizer, that the first encoder is to be customized including:
determining, by the encoder customizer based on a data feature weights, that the first encoder is to be customized, the data feature weights is received from a referred AI enabler.

16. The method of claim 7, the customizing the first encoder comprises:
muting, by the encoder customizer, the portion of the first encoder that processes overlapping features,
the muting including muting at least one of a neuron of the first encoder and a link of the first encoder.

17. The method of claim 7, wherein the configuring the evaluator comprises:
receiving, by the VFL configurator, labelled data information from the encoder selector;
determining, by the VFL configurator, a loss function to be used for performing VFL; and
configuring, by the VFL configurator, the evaluator using the labelled data information and the loss function.

18. The method of claim 17, wherein the configuring the evaluator comprises:
configuring, by the VFL configurator, a combination rule for labelled data originating from data sources selected for a first encoder and a second encoder, and the loss function.

19. The method of claim 7, wherein the configuring the joint classifier comprising:
receiving, by the VFL configurator, information indicative of an output layer structure of the first encoder and of the second encoder from an encoder customizer; and
configuring, by the VFL configurator, encoder outputs to the joint classifier based on the output layer structure of the first encoder and of the second encoder.

20. A system configured to:
receive, by an encoder selector, a Vertical Federated Learning (VFL) request from a VFL customer;
determine, by the encoder selector, data requirements and encoder requirements for solving a VFL task according to the VFL request,
the VFL task being splittable into a plurality of sub-tasks, the plurality of sub-tasks at least including a first sub-task and a second sub-task;
select, by the encoder selector based on the encoder requirements, a first encoder and a second encoder being from a pool of encoders in a communication network,
the first encoder configured to process a first set of features for solving the first sub-task, the second encoder configured to process a second set of features for solving the second sub-task;
select, by the encoder selector based on the data requirements, a first data source for the first encoder and a second for the second encoder, the selected data sources being from a pool of data sources, the first data source comprising the first set of features, and the second data source comprising the second set of features;
customize, by an encoder customizer, a first encoder by muting a portion of the first encoder, thereby generating a customized encoder;
configure, by a VFL configurator, at least one of an evaluator and a joint classifier; and
configure, by the VFL configurator, a privacy router to determine at least one of:
data exchange routes between the joint classifier and the evaluator,
labelled data merging routes between the evaluator and one or more of the selected data sources, and
backpropagation routes between the joint classifier and each one of a customized first encoder and a second encoder for back-propagating gradient values, wherein
the joint classifier, the evaluator and the privacy router configured for performing VFL.
